(19) United States
(12) Patent Application Publication
(10) Pub. No.: US 2005/0111142 A1
(43) Pub. Date: May 26, 2005

(54) Electromagnetic transducer element capable of suppressing rise in temperature of electromagnetic transducer film

(75) Inventor: Hirotaka Oshima, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/024,344

(22) Filed: Dec. 28, 2004

Related U.S. Application Data
(63) Continuation of application No. PCT/JP02/12631, filed on Dec. 3, 2002.

(51) Int. Cl. G11B 5/33; G11B 5/127

(52) U.S. Cl. 360/313

(57) ABSTRACT

An electrically conductive body is connected to an electromagnetic transducer film in a electromagnetic transducer element so as to form a path for current supplied to the electromagnetic transducer film. Heat is generated based on the electric resistance of the electromagnetic transducer film. A thermoelectric element such as a Peltier element is incorporated in the electrically conductive body. The thermoelectric element serves to absorb the heat. The supplied current is also utilized to drive the thermoelectric element. A wiring pattern and a power source dedicated to the thermoelectric element can be omitted in the electromagnetic transducer element. The electromagnetic transducer element is thus allowed to suppress rise in the temperature of the electromagnetic transducer film with a simple structure.

### BACKGROUND OF THE INVENTION

1. Field of the Invention

The present invention relates to an electromagnetic transducer element, such as a current-perpendicular-to-the-plane (CPP) structure electromagnetic element, including an electromagnetic transducer film and a pair of electrically conductive body sandwiching the electromagnetic transducer film so as to form a path for current supplied to the electromagnetic transducer film.

2. Description of the Prior Art

A thermoelectric element such as a Peltier element is sometimes incorporated in a magnetic head in the technical field of magnetic disk drives such as hard disk drives (HDDs). The Peltier element serves to suppress increase in the temperature of an electromagnetic transducer film in the magnetic head. This enables a raise in current value of the sensing current flowing through the electromagnetic transducer film. The sensing current of the raised current value serves to ensure a sufficient sensitivity of the magnetic head to a magnetic field leaked out of a magnetic recording medium.

As conventionally known, the Peltier element must receive electric current when the Peltier element establishes a cooling performance. Wiring patterns should be formed in the magnetic head so as to realize supply of electric current to the Peltier element. The structure of the magnetic head thus gets complicated.

### SUMMARY OF THE INVENTION

It is accordingly an object of the present invention to provide an electromagnetic transducer element, such as a current-perpendicular-to-the-plane (CPP) structure magnetoresistive element, capable of suppressing rise in THE temperature of an electromagnetic transducer film with a simple structure.

According to the present invention, there is provided an electromagnetic transducer element comprising: an electromagnetic transducer film; an electrically conductive body connected to the electromagnetic transducer film so as to form a path for current supplied to the electromagnetic transducer film; and a thermoelectric element incorporated in the electrically conductive body.

Heat is generated in the electromagnetic transducer element based on the electric resistance of the electromagnetic transducer film. The generate heat conducts to the electrically conductive body. The thermoelectric element serves to absorb the heat. The heat is dispersed into the electrically conductive body, so that the heat is radiated in an efficient manner. The electromagnetic transducer element allows suppression of rise in the temperature of the electromagnetic transducer film in this way.

In addition, the supplied current is also utilized to drive the thermoelectric element. A wiring pattern and a power source dedicated to the thermoelectric element can be omitted in the electromagnetic transducer element. The electromagnetic transducer element is thus allowed to suppress rise in the temperature of the electromagnetic transducer film with a simple structure. Here, a Peltier element may be employed as the thermoelectric element in the electromagnetic transducer element.

The electrically conductive body includes: a first electrically conductive piece connected to the electromagnetic transducer film; and a second electrically conductive piece isolated from the first electrically conductive piece by the thermoelectric element. In this case, the thermoelectric element is interposed between the first and second electrically conductive pieces completely isolated from each other in the electrically conductive body in the electromagnetic transducer element. The thermoelectric element serves to electrically connect the first and second electrically conductive pieces. The current thus reliably flows through the thermoelectric element. In addition, the supplied current is also utilized to drive the thermoelectric element. A wiring pattern and a power source dedicated to the thermoelectric element can be omitted in the electromagnetic transducer element. The electromagnetic transducer element is allowed to suppress rise in the temperature of the electromagnetic transducer film with a simple structure. Otherwise, the electrically conductive body may be divided into three or more pieces, for example. In this case, the thermoelectric element may be interposed between the individual pair of the adjacent electrically conductive pieces.

The electromagnetic transducer element may be a magnetoresistive (MR) element utilized in a magnetic recording disk medium drive such as a hard disk drive (HDD), for example. The magnetoresistive element may include a current-perpendicular-to-the-plane (CPP) structure magnetoresistive element. The CPP structure magnetoresistive element may comprise: a magnetoresistive film; upper and lower electrodes sandwiching the magnetoresistive film therebetween so as to form a path for current supplied to the magnetoresistive film; and a thermoelectric element incorporated in at least one of the upper and lower electrodes. A Peltier element may be utilized as the thermoelectric element.

The upper and lower electrodes often serve as upper and lower shielding layers in the CPP structure magnetoresistive element. The shielding layer is usually required to have a wider extent or coverage. Heat is supposed to easily disperse into the upper and lower shielding layers. This promotes the transmission of heat to the upper and lower shielding layers from the magnetoresistive film. The thermoelectric element thus serves to efficiently radiate the heat from the upper and lower electrodes. The CPP structure magnetoresistive element allows suppression of rise in the temperature of the magnetoresistive film with a simple structure.

The CPP structure magnetoresistive element may be mounted on a head slider incorporated in a magnetic disk drive such as a hard disk drive (HDD), on a head slider incorporated in other type of the magnetic recording medium drive such as a magnetic tape drive, and so on.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive (HDD);

FIG. 2 is an enlarged perspective view schematically illustrating a flying head slider according to a specific example;

FIG. 3 is a front view schematically illustrating a read/write electromagnetic transducer observed at a air bearing surface;

FIG. 4 is a sectional view taken along the line 4-4 in FIG. 3;

FIG. 5 is an enlarged partial sectional view taken along the line 5-5 in FIG. 3;

FIG. 6 is an enlarged front view schematically illustrating the structure of a magnetoresistive film according to a specific example;

FIG. 7 is an enlarged partial sectional view, corresponding to FIG. 5, for schematically illustrating a portion of a current-perpendicular-to-the-plane (CPP) structure magnetoresistive (MR) read element according to a specific example;

FIG. 8 is an enlarged partial sectional view, corresponding to FIG. 5, for schematically illustrating a portion of a CPP structure MR read element according to another specific example;

FIG. 9 is an enlarged partial sectional view, corresponding to FIG. 5, for schematically illustrating a portion of a CPP structure magnetoresistive MR read element according to still another specific example; and

FIG. 10 is an enlarged partial sectional view, corresponding to FIG. 5, for schematically illustrating a portion of a CPP structure magnetoresistive MR read element according to still another specific example.

### DESCRIPTION OF THE PREFERRED EMBODIMENTS

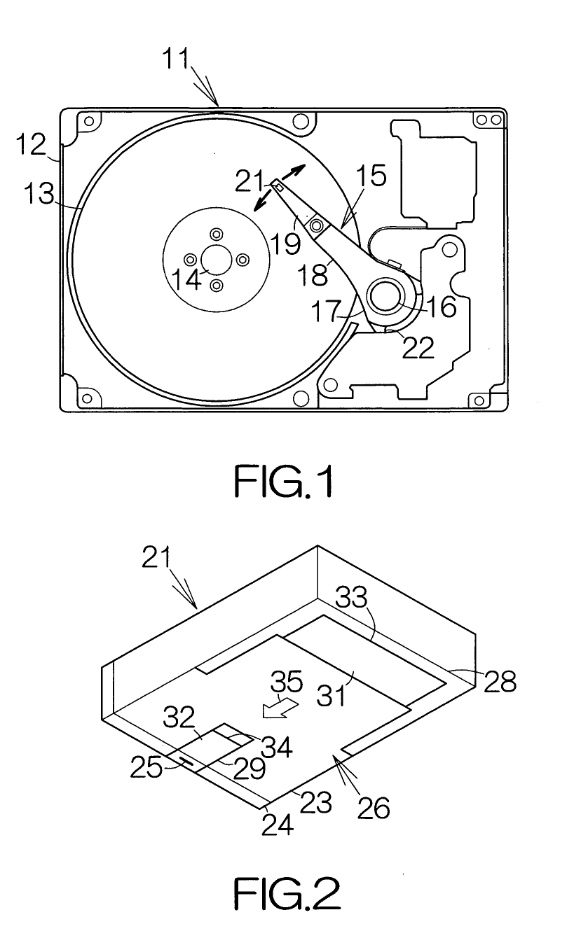

FIG. 1 schematically illustrates the inner structure of a hard disk drive (HDD) 11 as an example of a magnetic recording device or storage system. The HDD 11 includes a box-shaped main enclosure 12 defining an inner space of a flat parallelepiped, for example. At least one magnetic recording disk 13 is incorporated in the inner space within the main enclosure 12. The magnetic recording disk 13 is mounted on the driving shaft of a spindle motor 14. The spindle motor 14 is allowed to drive the magnetic recording disk 13 for rotation at a higher revolution speed such as 7,200 rpm or 10,000 rpm, for example. A cover, not shown, is coupled to the main enclosure 12 so as to define the closed inner space between the main enclosure 12 and itself.

A head actuator 15 is also incorporated within the inner space of the main enclosure 12. The head actuator 15 includes an actuator block 17 coupled to a vertical support shaft 16 for relative rotation. The actuator block 17 includes rigid actuator arms 18 extending from the vertical support shaft 16 in the horizontal direction. The actuator arms 17 are related to the front and back surfaces of the magnetic recording disk 13. The actuator block 17 may be made of aluminum, for example. Molding process may be employed to form the actuator block 17.

A head suspension 19 is attached to the tip or front end of the individual actuator arm 18. The head suspension 19 extends forward from front end of the actuator arm 18. As conventionally known, a flying head slider 21 is supported on the front end of the individual head suspension 19. The flying head sliders 21 are opposed to the surfaces of the magnetic recording disk or disks 13.

The head suspension 19 serves to urge the flying head slider 21 toward the surface of the magnetic recording disk 13. When the magnetic recording disk 13 rotates, the flying head slider 21 is allowed to receive airflow generated along the rotating magnetic recording disk 13. The airflow serves to generate a lift on the flying head slider 21. The flying head slider 21 is thus allowed to keep flying above the surface of the magnetic recording disk 13 during the rotation of the magnetic recording disk 13 at a higher stability established by the balance between the lift and the urging force of the head suspension 19.

A power source 22 such as a voice coil motor (VCM) is connected to the tail of the actuator block 17. The power source 22 drives the actuator block 17 for rotation around the support shaft 16. The rotation of the actuator block 17 induces the swinging movement of the actuator arms 18 and the head suspensions 19. When the actuator arm 18 is driven to swing about the support shaft 16 during the flight of the flying head slider 21, the flying head slider 21 is allowed to cross the recording tracks defined on the magnetic recording disk 13 in the radial direction of the magnetic recording disk 13. This radial movement serves to position the flying head slider 21 right above a target recording track on the magnetic recording disk 13. As conventionally known, in the case where two or more magnetic recording disks 13 are incorporated within the inner space of the main enclosure 12, a pair of the elastic head suspension 19 and the actuator arm 18 is disposed between the adjacent magnetic recording disks 13.

FIG. 2 illustrates a specific example of the flying head slider 21. The flying head slider 21 includes a slider body 23 made of Al₂O₃—TiC in the form of a flat parallelepiped. A head protection layer 24 made of Al₂O₃ (alumina) is coupled to the outflow or trailing end of the slider body 23. The read/write electromagnetic transducer 25 is contained within the head protection layer 24. A medium-opposed surface or bottom surface 26 is defined over the slider body 23 and the head protection layer 24 so as to face the magnetic recording disk 13 at a distance.

A front rail 28 and a rear rail 29 are formed on the bottom surface 26. The front rail 28 is designed to extend along the inflow or leading end of the slider body 23. The rear rail 29 is located near the outflow or trailing end of the slider body 23. Air bearing surfaces (ABSs) 31, 32 are respectively defined on the top surfaces of the front and rear rails 28, 29. The inflow ends of the air bearing surfaces 31, 32 are connected to the top surfaces of the front and rear rails 28, 29 through steps 33, 34, respectively. The read/write electromagnetic transducer 25 exposes the tip or front end at the air bearing surface 32. It should be noted that the front end of the read/write electromagnetic transducer 25 may be covered with a protection layer, made of diamond-like-carbon (DLC), extending over the air bearing surface 32.

The bottom surface 26 of the flying head slider 21 is designed to receive airflow 35 generated along the rotating magnetic recording disk 13. The steps 33, 34 serve to generate a relatively larger positive pressure or lift at the air bearing surfaces 31, 32. Moreover, a larger negative pressure is induced behind the front rail 28. The negative pressure is balanced with the lift so as to stably establish a flying attitude of the flying head slider 21. The flying head slider 21 may take any shape or form other than the aforementioned one.

FIG. 3 illustrates an enlarged detailed view of the read/write electromagnetic transducer 25 exposed at the air bearing surface 32. The read/write electromagnetic transducer 25 comprises an inductive write element or a thin film magnetic head 36 and a current-perpendicular-to-the-plane (CPP) structure electromagnetic transducer element or CPP structure magnetoresistive (MR) read element 37. The thin film magnetic head 36 is designed to write a magnetic bit data onto the magnetic recording disk 13 by utilizing a magnetic field induced in a conductive swirly coil pattern, not shown, for example. The CPP structure MR read element 37 is designed to detect a magnetic bit data by utilizing variation of the electric resistance in response to the inversion of the magnetic polarity in a magnetic field acting from the magnetic recording disk 13. The thin film magnetic head 36 and the CPP structure MR read element 37 are interposed between an Al₂O₃ (alumina) layer 38 as an upper half layer of the head protection layer 24 or overcoat film and an Al₂O₃ (alumina) layer 39 as a lower half layer of the head protection layer 24 or undercoat film.

The thin film magnetic head 36 includes an upper magnetic pole layer 41 exposing the front end at the air bearing surface 32, and a lower magnetic pole layer 42 likewise exposing the front end at the air bearing surface 32. The upper and lower magnetic pole layers 41, 42 may be made of FeN, NiFe, or the like, for example. The combination of the upper and lower magnetic pole layers 41, 42 establishes the magnetic core of the thin film magnetic head 36.

A non-magnetic gap layer 43 is interposed between the upper and lower magnetic pole layers 41, 42. The non-magnetic gap layer 43 may be made of Al₂O₃ (alumina), for example. When a magnetic field is induced at the conductive swirly coil pattern, a magnetic flux is exchanged between the upper and lower magnetic pole layers 41, 42. The non-magnetic gap layer 43 allows the exchanged magnetic flux to leak out of the air bearing surface 32. The thus leaked magnetic flux forms a magnetic field for recordation, namely, a write gap magnetic field.

The CPP structure MR read element 37 includes a lower electrode 44 extending over the upper surface of the alumina layer 39 as a basement insulation layer. The lower electrode 44 may have not only a property of electric conductors but also a soft magnetic property. If the lower electrode 44 is made of a soft magnetic electric conductor, such as NiFe, for example, the lower electrode 44 is also allowed to serve as a lower shielding layer for the CPP structure MR read element 37. A flattened surface 46 is defined on the upper surface of the lower electrode 44.

An electromagnetic transducer film such as a magnetoresistive (MR) film 47 is overlaid on the flattened surface 46. The magnetoresistive film 47 extends rearward from the tip or front end exposed at the air bearing surface 32 along the flattened surface 46. The lower electrode 44 contacts the lower boundary 47a of the magnetoresistive film 47 at least at the front end exposed at the air bearing surface 32. Electric connection is in this manner established between the magnetoresistive film 47 and the lower electrode 44. The magnetoresistive film 47 will be described later in detail.

A pair of hard magnetic domain controlling film 48 is likewise overlaid on the flattened surface 46. The domain controlling films 48 are allowed to extend along the air bearing surface 32. The domain controlling films 48 are designed to sandwich the magnetoresistive film 47 on the flattened surface 46 along the air bearing surface 32. The domain controlling films 48 may be made of a hard magnetic material such as CoPt, CoCrPt, or the like. The domain controlling films 48 serve to establish a magnetization across the magnetoresistive film 47 in parallel with the air bearing surface 32. When a biasing magnetic field is established based on the magnetization by the domain controlling films 48, a free layer of the magnetoresistive film 47 is allowed to enjoy the single domain property.

The flattened surface 46 is covered with an overlaid insulation layer 49. The overlaid insulation layer 49 may be made of an insulating material such as Al₂O₃, SiO₂, or the like. The domain controlling films 48 are thus interposed between the overlaid insulation layer 49 and the lower electrode 44. The top surface or upper boundary 47b of the magnetoresistive film 47 gets exposed out of the overlaid insulation layer 49 at a location adjacent the air bearing surface 32.

An upper electrode 51 is located on the overlaid insulation layer 49. The upper electrode 51 is allowed to contact the upper boundary 47b of the magnetoresistive film 47 at least at the front end exposed at the air bearing surface 32. Electric connection is thus established between the magnetoresistive film 47 and the upper electrode 51. If the upper electrode 51 is made of a soft magnetic electric conductor, such as NiFe, for example, the upper electrode 51 is also allowed to serve as an upper shielding layer for the CPP structure MR read element 37. The distance between the aforementioned lower electrode 44 and the upper electrode 51 determines a linear resolution of recordation along a recording track on the magnetic recording disk 13.

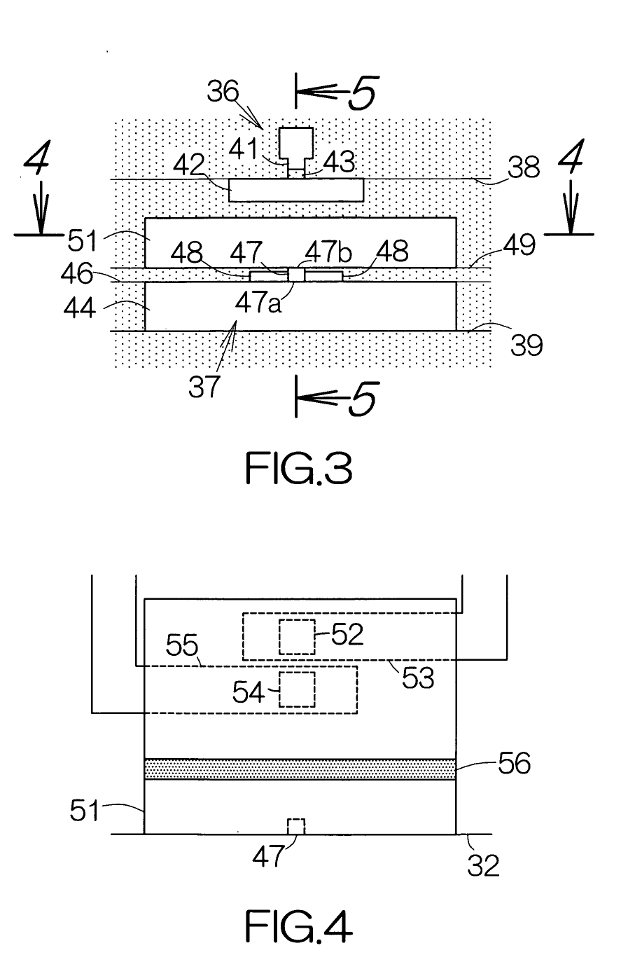

As shown in FIG. 4, the rear end of the upper electrode 51 is connected to a connection terminal 52, for example. The connection terminal 52 is connected to a lead layer 53. The lead layer 53, the connection terminal 52 and the upper electrode 51 in combination serve to function as an electrically conductive body for forming a path for a sensing current supplied to the magnetoresistive film 47. The rear end of the lower electrode 44 is likewise connected to a connection terminal 54. The connection terminal 54 is connected to a lead layer 55. The lead layer 55, the connection terminal 54 and the lower electrode 44 in combination serve to function as an electrically conductive body for forming a path for a sensing current supplied to the magnetoresistive film 47.

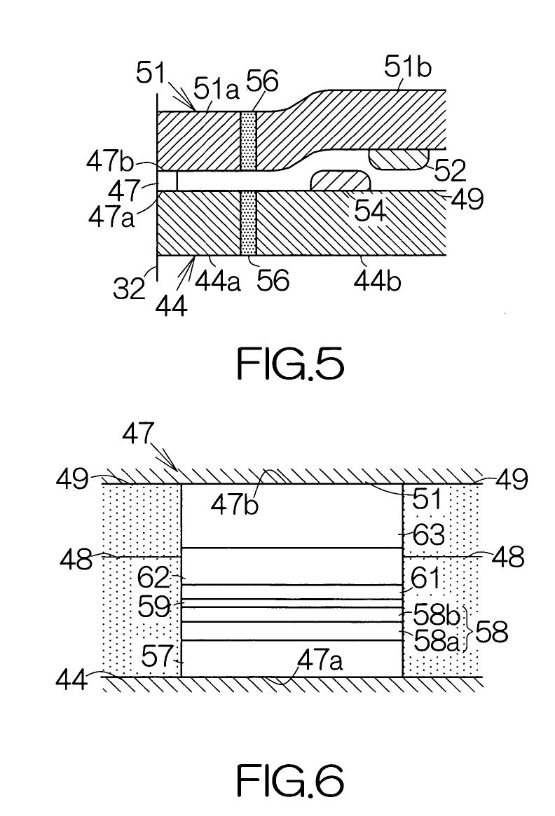

As shown in FIG. 5, thermoelectric elements 56, 56 are incorporated within the upper and lower electrodes 51, 44, respectively, according to an example of the present invention. Here, the thermoelectric element 56 serves to isolate first and second electrically conductive pieces 51a, 51b from each other in the upper electrode 51. The first electrically conductive piece 51a is received on the upper surface of the magnetoresistive film 47. The rear end of the second electrically conducive piece 51b is received on the connection terminal 52. Similarly, the thermoelectric element 56 serves to isolate first and second electrically conductive pieces 44a, 44b from each other in the lower electrode 44. The magnetoresistive film 47 is received on the first electrically conductive piece 44a. The second electrically conductive piece 44b receives the connection terminal 54.

The thermoelectric element 56 may be a Peltier element, for example. The Bi₂Te₃/Sb₂Te₃ alloy may be employed to form the Peltier element, for example. The alloy serves to establish the resistivity ρ of 1 [mΩcm] approximately, the Seebeck effect coefficient S of 200 [μV/K] approximately, and the performance index ZT of 0.9 approximately, as mentioned by G. Mahan, B. Sales, and J. Sharp, Phys. Today, 50, 42(1997).

When the CPP structure MR read element 37 is opposed to the surface of the magnetic recording disk 13 for reading magnetic information data, the magnetization of the free ferromagnetic layer is allowed to rotate in the magnetoresistive film 47 in response to the inversion of the magnetic polarity applied from the magnetic recording disk 13. The rotation of the magnetization in the free ferromagnetic layer induces variation of the electric resistance in the magnetoresistive film 47. When a sensing current is supplied to the magnetoresistive film 47 through the upper and lower electrodes 51, 44, a variation in the level of any parameter such as voltage appears, in response to the variation in the magnetoresistance, in the sensing current output from the upper and lower electrodes 51, 44. The variation in the level can be utilized to detect a magnetic bit data recorded on the magnetic recording disk 13.

Here, the Joule heat is generated in the magnetoresistive film 47 based on the electric resistance. The overlaid insulation layer 49 hinders radiation of the heat from the magnetoresistive film 47. On the other hand, the heat of the magnetoresistive film 47 efficiently conducts through the upper and lower electrodes 51, 44 since the upper and lower electrodes 51, 44 are made of an electrically conductive material. The transmission of the heat in the upper electrode 51 is promoted from the end near the magnetoresistive film 47 toward the end near the connection terminal 52 with the assistance of the Peltier effect of the thermoelectric element 56. The transmission of the heat in the lower electrode 44 is likewise promoted from the end near the magnetoresistive film 47 toward the end near the connection terminal 54 with the assistance of the Peltier effect of the thermoelectric element 56. When the sensing current of 2 [mA] is supplied to the thermoelectric elements 56, the Peltier effect is induced in the thermoelectric elements 56 to absorb the heat of 200 [μW] approximately.

The aforementioned CPP structure MR read element 37 allows a wider extent of the upper and lower electrodes 51, 44 since the upper and lower electrodes 51, 44 are utilized as shielding layers. The heat of the magnetoresistive film 47 thus tends to conduct to the upper and lower electrodes 51, 44. The Peltier effect of the thermoelectric elements 56 serves to radiate the Joule heat away from the magnetoresistive film 47 in an efficient manner. The thermoelectric elements 56 thus serve to suppress increase in the temperature of the magnetoresistive film 47 with a simple structure. This enables a raise in current value of the sensing current flowing through the magnetoresistive film 47. The sensing current of the raised current value serves to ensure a sufficient sensitivity of the CPP structure MR read element 37 to a magnetic field leaked out of the magnetic recording disk 13.

The thermoelectric element 56 is interposed between the first and second electrically conductive pieces 51a, 44a, 51b, 44b completely isolated from each other in the upper and lower electrodes 51, 44 in the CPP structure MR read element 37. Since the thermoelectric elements 56 made of the Peltier elements have a resistance lower than that of the overlaid insulation layer 49 surrounding the thermoelectric elements 56, the sensing current thus reliably flows through the thermoelectric elements 56. In addition, the supplied sensing current is also utilized to drive the thermoelectric elements 56. Wiring patterns and power sources dedicated to the thermoelectric elements 56 can be omitted in the CPP structure MR read element 37. The CPP structure MR read element 37 is allowed to suppress rise in the temperature of the magnetoresistive film 47 with a simple structure.

A brief description will be made on a method of making the CPP structure MR read element 37. For example, a groove may be formed in the lower electrode 44 based on a conventional etching process. The groove is designed to divide the lower electrode 44 into pieces. In this case, a photoresist film may be formed on the lower electrode 44 for defining a void corresponding to a pattern of the groove, for example. The distance between the obtained pieces sets the dimensions of the thermoelectric element 56. The thermoelectric element 56 is then formed in the groove. Sputtering, molecular beam epitaxy (MBE), metallic organic chemical vapor deposition (MOCVD), or the like, may be employed to form the thermoelectric element 56. The same processes may be utilized to form the thermoelectric element 56 in the upper electrode 51.

Here, a brief description will be made on the structure of the magnetoresistive film 47. FIG. 6 illustrates an example of the magnetoresistive film 47. The magnetoresistive film 47 is a so-called spin valve film. Specifically, the magnetoresistive film 47 includes a Ta basement layer 57, a free ferromagnetic layer 58, a non-magnetic intermediate layer 59 made of an electrically-conductive material, a pinned ferromagnetic layer 61, a pinning layer or antiferromagnetic layer 62 and an electrically conductive protection cap layer 63, overlaid one another in this sequence. The magnetization of the pinned ferromagnetic layer 61 is fixed in a specific lateral direction under the influence of the antiferromagnetic layer 62. Here, the free ferromagnetic layer 58 may include a NiFe layer 58a overlaid on the upper surface of the Ta basement layer 57, and a CoFe layer 58b overlaid on the upper surface of the NiFe layer 58a, for example. The non-magnetic intermediate layer 59 may be made of Cu or the like. The pinned ferromagnetic layer 61 may be made of a ferromagnetic material such as CoFe. The antiferromagnetic layer 62 may be made of an antiferromagnetic material such as IrMn or PdPtMn, for example. The protection cap layer 63 may be made of Au, Pt, or the like.

Alternatively, the magnetoresistive film 47 may employ a tunnel-junction film. The tunnel-junction film requires an insulating non-magnetic intermediate layer, in place of the aforementioned non-magnetic intermediate layer 59, between the free and pinned ferromagnetic layers 58, 61. The insulating non-magnetic intermediate layer may be made of Al₂O₃, for example.

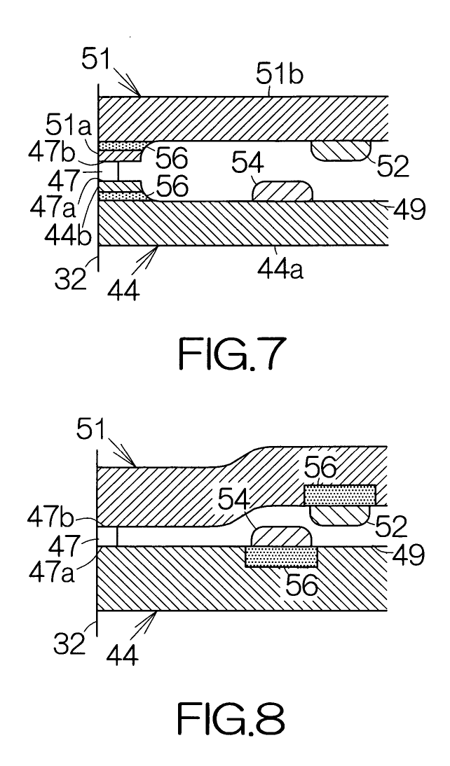

As shown in FIG. 7, the lower and upper electrodes 44, 51 may be divided into first and second electrically conductive pieces 44a, 51a, 44b, 51b overlaid one another, for example. Here, the first electrically conductive piece 44a is designed to extend rearward along the upper surface of the alumina layer 39 from the front end exposed at the air bearing surface 32. The connection terminal 54 is received at the rear end of the first electrically conductive piece 44a. The thermoelectric element 56 is overlaid on the upper surface of the first electrically conductive piece 44a at a location adjacent the air bearing surface 32. The second electrically conductive piece 44b extends on the upper surface of the thermoelectric element 56. The magnetoresistive film 47 is received on the upper surface of the second electrically conductive piece 44b. The magnetoresistive film 47 receives the first electrically conductive piece 51a of the upper electrode 51. The first electrically conductive piece 51a receives the thermoelectric element 56 and the second electrically conductive piece 51b of the upper electrode 51 in this sequence.

As shown in FIG. 8, the thermoelectric elements 56 may be located between the lower electrode 44 and the connection terminal 54 as well as between the upper electrode 51 and the connection terminal 52, for example. The thermoelectric element 56 serves to isolate the connection terminal 54 from the lower electrode 44. The thermoelectric element 56 likewise serves to isolate the connection terminal 52 from the upper electrode 51. Here, the lower and upper electrodes 44, 51 correspond to a first electrically conductive piece according to the present invention. The connection terminals 54, 52 correspond to a second electrically conductive piece according to the present invention. The CPP structure MR read element 37 enables an efficient radiation of the Joule heat dispersed over the upper and lower electrodes 51, 44 from the magnetoresistive film 47. The CPP structure MR read element 37 is capable of suppressing rise in the temperature of the magnetoresistive film 47 with a simple structure. As is apparent from FIG. 8, the thermoelectric elements 56 may be embedded in the lower and upper electrodes 44, 51, respectively. Otherwise, the thermoelectric elements 56 may be formed on the surfaces of the lower and upper electrodes 44, 51, respectively, as is apparent from FIG. 9.

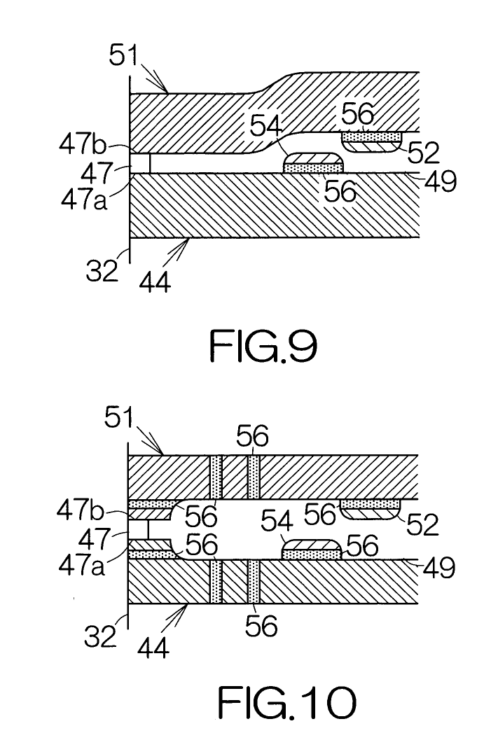

The CPP structure MR read element 37 may allow disposition of the thermoelectric elements 56 in a single electric conductive body, as shown in FIG. 10, for example. In this case, the thermoelectric elements 56 may divide the upper and lower electrodes 51, 44, the connection terminals 52, 54 and/or the lead layers 53, 55 into pieces. Three or more pieces may be established. The CPP structure MR read element 37 enables an efficient radiation of the Joule heat dispersed over the upper and lower electrodes 51, 44 from the magnetoresistive film 47. The CPP structure MR read element 37 is capable of suppressing rise in the temperature of the magnetoresistive film 47 with a simple structure.

It should be noted that the definition “thermoelectric element incorporated in” also includes the thermoelectric element 56 interposed between the magnetoresistive film 47 and the upper electrode 51 as well as between the magnetoresistive film 47 and the lower electrode 44.

1. An electromagnetic transducer element comprising:
an electromagnetic transducer film;
an electrically conductive body connected to the electromagnetic transducer film so as to form a path for current supplied to the electromagnetic transducer film; and
a thermoelectric element incorporated in the electrically conductive body.

2. The electromagnetic transducer element according to claim 1, wherein said electromagnetic transducer film is a magnetoresistive film.

3. The electromagnetic transducer element according to claim 1, wherein said thermoelectric element is a Peltier element.

4. The electromagnetic transducer element according to claim 3, wherein said electrically conductive body includes:
a first electrically conductive piece connected to the electromagnetic transducer film; and
a second electrically conductive piece isolated from the first electrically conductive piece by the thermoelectric element.

5. The electromagnetic transducer element according to claim 3, wherein said electrically conductive body is divided into electrically conductive pieces, said thermoelectric element being interposed between the adjacent electrically conductive pieces.

6. The electromagnetic transducer element according to claim 3, wherein said electromagnetic transducer film is a magnetoresistive film.

7. A current-perpendicular-to-the-plane structure magnetoresistive element comprising:
a magnetoresistive film;
upper and lower electrodes sandwiching the magnetoresistive film therebetween so as to form a path for current supplied to the magnetoresistive film; and
a thermoelectric element incorporated in at least one of the upper and lower electrodes.

8. The current-perpendicular-to-the-plane structure magnetoresistive element according to claim 7, wherein said thermoelectric element is a Peltier element.

9. The current-perpendicular-to-the-plane structure magnetoresistive element according to claim 8, wherein said electrically conductive body includes:
a first electrically conductive piece connected to the magnetoresistive film; and
a second electrically conductive piece isolated from the first electrically conductive piece by the thermoelectric element.

10. The current-perpendicular-to-the-plane structure magnetoresistive element according to claim 8, wherein said electrically conductive body is divided into electrically conductive pieces, said thermoelectric element being interposed between the adjacent electrically conductive pieces.
